(19) United States
(12) Patent Application Publication
(10) Pub. No.: US 2012/0274838 A1
(43) Pub. Date: Nov. 1, 2012

(54) ILLUMINATION AND IMAGE CAPTURE

(75) Inventors: Ross Teggatz, McKinney, TX (US); Wayne Chen, Plano, TX (US); Amer Atrash, Richardson, TX (US)

(73) Assignee: TRIUNE IP LLC, Richardson, TX (US)

(21) Appl. No.: 13/274,889

(22) Filed: Oct. 17, 2011

Related U.S. Application Data
(60) Provisional application No. 61/393,824, filed on Oct. 15, 2010.

(51) Int. Cl. H04N 5/225

(52) U.S. Cl. 348/371; 348/E05.029

(57) ABSTRACT

The invention provides advances in the arts with useful and novel methods and systems for providing illumination in association with image capture. Disclosed preferred embodiments of the invention include illumination apparatus adjustable in angle with respect to the image capturing apparatus and target locus. Preferred embodiments also include variability of the illumination intensity by means of controlling the power to the illuminations apparatus. Additional preferred embodiments also include techniques for selecting from or combining a plurality of images based on their illumination characteristics for providing and improved image output.

### PRIORITY ENTITLEMENT

This application is entitled to priority based on Provisional Patent Application Ser. No. 61/393,824 filed on Oct. 15, 2010, which is incorporated herein for all purposes by this reference. This application and the Provisional Patent Application have at least one common inventor.

### TECHNICAL FIELD

The invention relates to camera flash methods and associated systems. More particularly, the invention relates to methods and systems designed for use with flash driver circuits and systems for driving light sources in association with image capturing apparatus.

### BACKGROUND OF THE INVENTION

Images recorded by image capturing apparatus can be poor if the lighting of the target locus is not well-suited to image capture. Problems may include under- or over-lighting, excessive glare, or with human subjects, red-eye effect. The red-eye effect in photography is the problem of rendering pupils red in color photographs. The red-eye problem occurs when a photographic flash is used in close proximity to the camera lens with a low ambient light target locus. It is known to attempt to eliminate the red-eye effect in a number of ways. For example, in some instances, a flash is aimed at a nearby surface such as a reflector or umbrella in order to change the direction of the flash and diffuse the light emitted from the flash. In another approach, the flash is positioned a distance away from the camera. Such positioning ensures that the light from the flash arrives at the target locus at an oblique angle. Thus, the light emitted by the flash enters the eye from a direction other than along the optical axis of the image capturing apparatus and is reflected back from the retina in the same direction, not directly toward the lens of the camera or video equipment. Because of this, the retina is not visible to the lens and the red-eye effect is avoided. A major problem with these approaches to red-eye reduction is that equipment external to the camera is required. This can be a major inconvenience in most non-studio settings. Another red-eye avoidance technique is to precede the main flash with one or more low-power flashes, designed to cause the pupils to contract prior to the activation of the main flash. This approach does not work when a target subject blinks or glances away during the low-power flash event. Additionally, subjects can sometimes look unnatural with constricted pupils. Moreover, these red-eye reduction techniques do not address the problem of reducing glare or softening light intensity, which can be problematic with metallic, reflective, or light-colored subjects.

Due to the foregoing and other problems and potential advantages, improved flash methods and systems, particularly for LED-lighted image capturing systems, would be useful contributions to the applicable arts.

### SUMMARY OF THE INVENTION

In carrying out the principles of the present invention, in accordance with preferred embodiments, the invention provides advances in the arts with useful and novel methods and systems for reducing red-eye effect and providing improved lighting for image capture. All possible variations within the scope of the invention cannot, and need not, be shown. It should be understood that the invention may be used with various cameras and imaging apparatus.

According to one aspect of the invention, in an example of a preferred embodiment, a method is disclosed for providing illumination while capturing a digital image includes steps for providing image capturing apparatus and illumination apparatus. The illumination apparatus is positioned at an oblique angle relative to the image capturing apparatus and a selected target or location. Simultaneously, light is caused to be emitted from the illumination apparatus and the digital image is captured using the image capturing apparatus. The arrangement of the illumination and image capturing apparatus relative to the target ensures that the light reflected from the target directly towards the image capturing apparatus has an intensity less than the peak intensity of the emission from the illumination apparatus.

According to another aspect of the invention, preferred embodiments of methods for providing illumination while capturing a digital image include steps for dynamically changing the flash position angle. This may be accomplished by moving the flash apparatus, or by moving the image capturing apparatus.

According to another aspect of the invention, a preferred embodiment of a method for providing illumination while capturing a digital image includes steps for varying the intensity of light emitted by the flash apparatus.

According to another aspect of the invention, a preferred embodiment of a method for providing illumination while capturing a digital image includes the deployment of LED illumination apparatus.

According to another aspect of the invention, a preferred embodiment of a method for providing illumination while capturing a digital image includes steps for selecting from a plurality of images captured at multiple flash position angles or light intensities

According to another aspect of the invention, a preferred embodiment of a method for providing illumination while capturing a digital image includes steps for combining multiple images captured at multiple flash angles or light intensities

The invention has advantages including but not limited to providing one or more of the following features, reduced red-eye effect and/or generally improved image capture lighting. These and other advantageous, features, and benefits of the invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the description and drawings in which:

FIG. 1 is a simplified schematic drawing illustrating examples of preferred embodiments of illumination and image capture systems and methods of the invention;

FIG. 2 is a simplified schematic diagram depicting further examples of preferred embodiments of illumination and image capture systems and methods of the invention;

FIG. 3 is a simplified schematic diagram portraying additional examples of preferred embodiments of illumination and image capture systems and methods according to the invention; and

FIG. 4 is a simplified schematic diagram showing an example of a further details of a preferred embodiment of an illumination and image capture system and method according to the invention.

References in the detailed description correspond to like references in the various drawings unless otherwise noted. Descriptive and directional terms used in the written description such as front, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DESCRIPTION OF PREFERRED EMBODIMENTS

Although the making and using of various specific exemplary embodiments of the invention are discussed herein, it should be appreciated that the systems and methods described and shown exemplify inventive concepts which can be embodied in a wide variety of specific contexts. It should be understood that the invention may be practiced in various applications and embodiments without altering the principles of the invention. For purposes of clarity, detailed descriptions of functions, components, and systems familiar to those skilled in the applicable arts are not included. In general, the invention provides improved illumination and image capture methods and systems. Preferred embodiments of the invention include methods and systems for use in association with image capturing apparatus of various types. The invention is described in the context of representative example embodiments representative of principles suitable for broader application. Although variations in the details of the embodiments are possible, each has advantages over the prior art.

Within the scope of the invention, methods have been devised through which red-eye reduction can be achieved by utilizing illumination apparatus, such as LED flash devices, in a novel way that takes advantage of their light emission characteristics. It should be appreciated that the techniques disclosed and described herein with respect to examples of red-eye reduction applications may also be used to reduce glare or provide even lighting in the general context of image capture. Illumination apparatus is also referred to herein generally as “flash” apparatus. In specific examples of presently preferred embodiments of the invention, LED flash apparatus are shown and described, although the systems and methods of the invention may be implemented with alternative illumination apparatus. It should be understood that the methods and systems described and shown may be used individually, or in various combinations. System embodiments of the invention may also combine various elements and methods for use with one or more flash apparatus including multiple LED elements, arrays of LED elements, and/or other illumination apparatus in a larger image capture system.

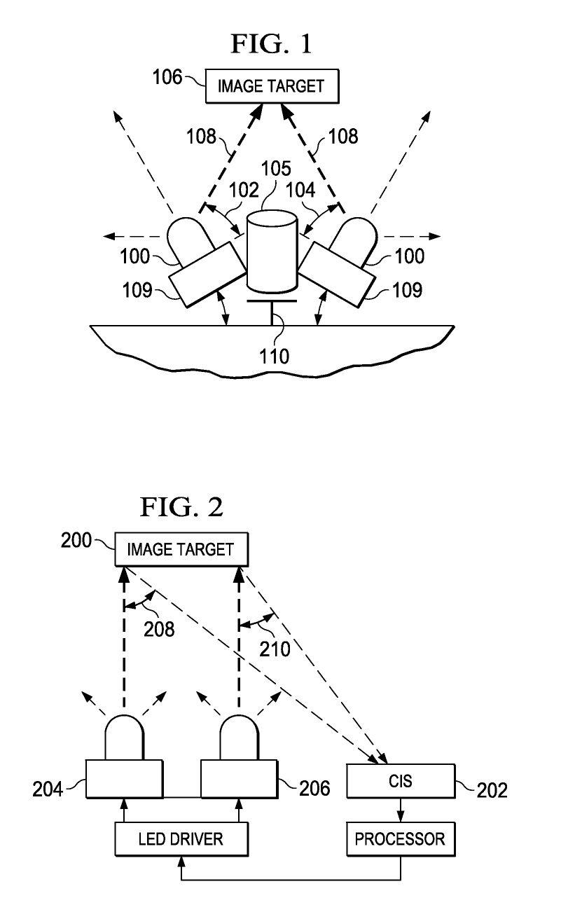

Referring initially to FIG. 1, an arrangement is shown in which illumination apparatus, such as for example flash LEDs 100, are mounted at angles 102, 104 relative to the image capturing apparatus 105 and the object or area that is to be illuminated, herein generally referred to as the “target locus”, “subject”, or “target” 106. Due to the deployment of the LEDs at selected angles relative to the target locus, the light emission, indicated at arrows 108, from the LEDs 100 directly towards the target 106, and reflected to the image capturing apparatus 105, is less than the peak intensity of the LED light emission. The peak emission is oriented towards the target 100, but at an angle, e.g., 102, 104, such that the peak emission strikes the target 106 at an oblique angle. This indirect illumination reduces or eliminates red-eye from the captured image. The angles at which the LEDs may be mounted are preferably independently adjustable, both in the horizontal and vertical axes. Preferably, the LEDs are affixed to a pivoting mechanism 109 to readily facilitate repositioning. In preferred embodiments, the pivotable LEDs 100 are equipped with actuators 110 such as electro-mechanical servos or MEMs devices. In this way, the illumination apparatus may be repositioned dynamically to adapt to ambient lighting conditions, distance to target locus, or other factors.

It should be appreciated that, without departure from the scope of the invention, the illumination apparatus may be implemented in the form of more than one light source. Light sources may include LEDs or arrays of LEDs mounted at different angles, which can preferably be positioned, repositioned, and illuminated independently and/or simultaneously. This technique can be used create a more uniform emission of light from the illumination apparatus and reduce the relative magnitude of the peak illumination compared to the average illumination. The peak light intensity directed toward the target locus at substantially the same angle as the lens relative to the target will be reduced, as a result eliminating or greatly diminishing the occurrence of red-eye effect, wash-out, or glare. In an alternative implementation, the angle of the image capture apparatus relative to the light sources can be adjusted mechanically and varied. To achieve this, the imaging apparatus may be mounted on a movable or adjustable surface and supplied with actuators which can be controlled electronically. This allows another degree of adjustability to the lighting system. Using the principle of controlling and maintaining the difference between the flash angle of incidence relative to the angle of the image capturing apparatus, multiple images at multiple illumination angles can be captured. The images can then be checked for the presence of red-eye or glare and the best image can then be selected from those available for outputting or further processing. Alternatively, the images can be combined to create an optimum image without red-eye, glare, or other defects, using suitable enhancement algorithms. Instead of or in combination with capturing multiple images at distinct angles, the angle of incidence can also be changed during a flash event. This technique distributes the peak illumination across the target locus, providing a more even exposure and reducing or eliminating red-eye, glare, or other problems in the image.

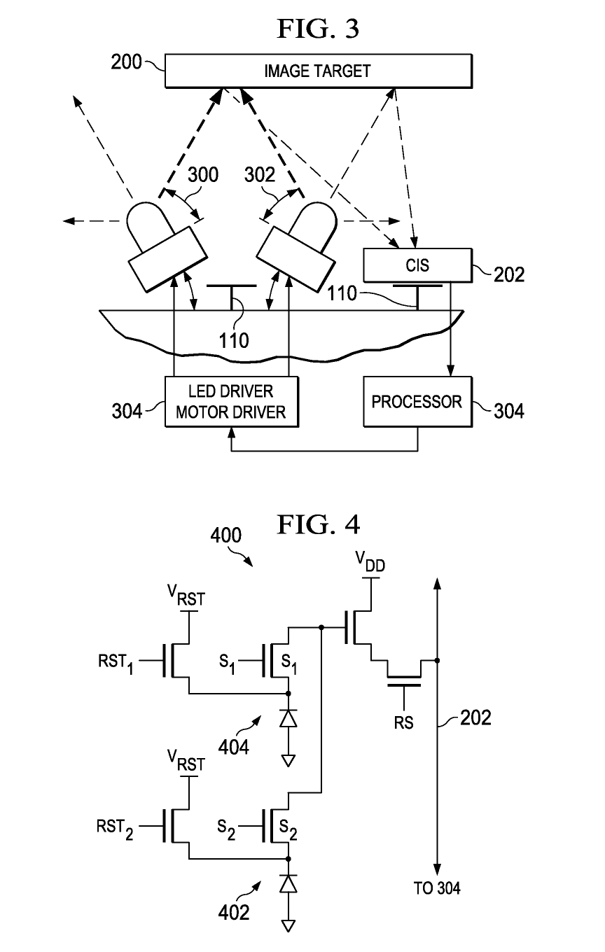

In another variation of an alternative embodiment of methods of the invention, the drive current of the illumination apparatus, e.g., LEDs, can be ramped up and multiple images can be made, preferably in rapid succession at various light levels. Images captured with overly bright illumination that results in red-eye can subsequently be deleted or processed by combining them with images captured at lower illumination levels. Along these same lines, another approach is to ramp the drive current of the LEDs and search for the onset of red-eye in the captured images. This may be done over a series of several image captures or by monitoring a single image during capture and adjusting the current accordingly. Those skilled in the arts will perceive that in addition to or instead of ramping the illumination source current continuously, the current may be pulsed using an adjustable pulse width modulation (PWM). The duty cycle, amplitude, and/or frequency of the PWM can be increased to increase the effective illumination current and thus the emitted light intensity. FIG. 2 depicts a system and method in which an image of the target locus 200 is captured using image capturing apparatus such as a digital camera 202 having a CMOS or CCD image sensor. Flash apparatus such as the two separate arrays of LEDs 204, 206 shown, are arranged with a suitable flash angles 208, 210. Preferably, the image capturing apparatus 202 may be used to assist in controlling the LED intensity by providing feedback concerning the perceived quality of captured images. It should be appreciated that the system and method preferably provides flexibility as to adjusting one or more of the flash angle, duration of illumination, and intensity of illumination. This flexibility can be achieved by controlling the current supply to the flash apparatus. Additionally or alternatively, the image capturing apparatus may include processing capabilities for correlating multiple pixels, images, and illumination adjustments during and/or subsequent to image capture events. Another aspect of the invention is illustrated in FIG. 3, in which actuators 110 are shown. The actuators 110 are configured for adjusting the illumination apparatus 100 and/or the image capturing apparatus 202 in order to affect the flash angle 300, 302 and/or illumination intensity. Preferably, the image processing apparatus includes the capability for providing command and control suitable for doing so 304, in addition to the features previously described herein.

As with target locus lighting techniques and image capture techniques disclosed herein, further variations in image processing steps may be used without departing from the scope of the invention. Image processing algorithms can be used to capture multiple images with different integration times. Then each pixel can be examined and a determination made, preferably using a suitable automated process, whether saturation has occurred (i.e., too bright), or if no photons where collected (i.e., too dark). Subsequently, the same pixels can be used from other captured images having a shorter integration time in the case where the examined pixel was saturated, or using an image having a longer integration time in the case where the examined pixel was too dark. The selected pixels may then be placed together to form an assembled composite image for outputting or further processing. Now referring primarily to FIG. 4, a simplified schematic diagram is presented to show an example of a CMOS image sensor internal to image capturing apparatus such as those shown and described herein, e.g., 202. As shown, the CMOS photodetector pixel element 400 is provided with two independent resets RST1, RST2. In operation, one photodetector, e.g., 402, is used to capture the image, during which time the other photodetector, e.g., 404, is held in reset and released at a later time to achieve a different integration time of the image. Thus, two different integration times may be provided for the active pixel element, allowing the processor 304 to then choose which to use for the final image. This is accomplished by using suitable image processing techniques available in the applicable arts.

It should be appreciated by those skilled in the arts that the above-described techniques may be used in various combinations to achieve improved image capture lighting, preferably adaptable to ambient light conditions, and reduces red-eye effect. The methods and systems of the invention provide one or more advantages including but not limited to improved performance and/or efficiency in driver circuits. While the invention has been described with reference to certain illustrative embodiments, those described herein are not intended to be construed in a limiting sense. Variations or combinations of steps or materials in the embodiments shown and described may be used in particular cases without departure from the invention. Although the presently preferred embodiments are described herein in terms of particular examples, modifications and combinations of the illustrative embodiments as well as other advantages and embodiments of the invention will be apparent to persons skilled in the arts upon reference to the drawings, description, and claims.

We claim:

1. A method for providing momentarily illumination for capturing a digital image comprising the steps of:
providing image capturing apparatus;
providing a flash apparatus positioned at an oblique angle relative to the image capturing apparatus and a selected target locus;
causing light to be emitted from the flash apparatus; and simultaneously
capturing a digital image of the target locus with the image capturing apparatus;
wherein the light reflected from the target directly towards the image capturing apparatus has an intensity less than the peak intensity of the emission from the flash apparatus.

2. The method according to claim 1 further comprising the step of dynamically changing the flash position angle in real time.

3. The method according to claim 1 further comprising the step of dynamically changing the flash position angle by moving the flash apparatus.

4. The method according to claim 1 further comprising the step of dynamically changing the flash position angle by moving the image capturing apparatus.

5. The method according to claim 1 further comprising the step of illuminating the flash apparatus at a plurality of intensities.

6. The method according to claim 1 further comprising the step of illuminating the flash at a plurality of intensities during image capture.

7. The method according to claim 1 further comprising the step of dynamically changing the flash position angle during image capture.

8. The method according to claim 1 further comprising the step of dynamically changing the flash position angle by moving one or more flash apparatus during image capture.

9. The method according to claim 1 further comprising the step of dynamically changing the flash position angle by moving the image capturing apparatus during image capture.

10. The method according to claim 1 further comprising the step of independently controlling the illumination intensity of each flash.

11. The method according to claim 1 further comprising the step of controlling flash intensity by varying current supplied to the flash.

12. The method according to claim 1 further comprising the step of controlling flash intensity by varying the duty cycle of current supplied to the flash.

13. The method according to claim 1 further comprising the step of controlling flash intensity by varying the frequency of current supplied to the flash.

14. The method according to claim 1 further comprising the step of controlling flash intensity by modulating current supplied to the flash.

15. The method according to claim 1 wherein the flash apparatus comprises a plurality of LEDs.

16. The method according to claim 15 further comprising the step of dynamically changing the flash position angle by moving one or more of the plurality of LEDs.

17. The method according to claim 15 further comprising the step of illuminating the plurality of LEDs at a plurality of intensities.

18. The method according to claim 15 further comprising the step of dynamically changing the flash position angle by moving one or more of the plurality of LEDs during image capture.

19. The method according to claim 15 further comprising the step of illuminating the plurality of LEDs at a plurality of intensities during image capture.

20. The method according to claim 15 further comprising the step of independently controlling the illumination intensity of each of the LEDs.

21. A method for capturing a digital image comprising the steps of:
providing image capturing apparatus adapted for capturing a plurality of image elements at a plurality of integration times;
providing a flash apparatus positioned at an oblique angle relative to the image capturing apparatus and a selected target locus;
causing light to be emitted from the flash apparatus;
capturing a plurality of image elements from light reflected off the target locus, the plurality of image elements having a plurality of integration times; and
selecting and combining image elements having different integration times and thereby providing a digital image output comprising the combined image elements.
